(19) United States
(12) Patent Application Publication
(10) Pub. No.: US 2007/0124796 A1
(43) Pub. Date: May 31, 2007

(54) Appliance and method for client-sided requesting and receiving of information

(76) Inventor: Erland Wittkotter, Hayward, CA (US)

Correspondence Address: Erland Wittkotter, Apt. 174, 25200 Carlos Bee Blvd., Hayward, CA, 94542, US

(21) Appl. No.: 11/286,831

(22) Filed: Nov. 25, 2005

(30) Foreign Application Priority Data
Nov. 25, 2005 (DE) 10 2004 057 034.5

(51) Int. Cl. H04N 7/173; H04N 7/16; H04N 7/08

(52) U.S. Cl. 725/136; 725/137; 725/100; 725/87

(57) ABSTRACT

The Invention pertains to a device for the client-sided requesting, transmitting, receiving, delivering, outputting and displaying of server-sided stored data by means of context data and time index data and/or content identifier data, which are transferred to the server and to which server-sided additional data are stored and can be requested and can be displayed or outputted on the client-side.

### BACKGROUND OF THE INVENTION

The present invention pertains to an apparatus and method for the client-sided requesting, transmitting, receiving, delivering, representing, outputting and displaying of server-sided stored data, as set forth in the classifying portion of Claim 1.

### DESCRIPTION TO THE RELATED ART

By the transmission of audio/video data to client-sided data processing units in the form of a set top box (STB) or to a TV tuner card, which is integrated in a commercial PC, the opportunity is provided to create interactive services by adding additional data. Since the extent or amount of provided data is limited within the data stream, such as into teletext or VBI, it is difficult to make all desired or desirable additional data accessible to the user.

The audio visual data, in particular digital video data, are received by means of a unidirectional receiving channel (broadcast channel), which is realized as satellites, cable or terrestrial connection. The set-top boxes are typically equipped with a (unidirectional) backward channel—such as is used to order video-on-demand content, which allows the transmission of a relatively small set of ordering information. This backward channel is typically also used for the realization of interactive television or interactive services.

For example, data are sent to the television set via the VBI by means of the TV transmitter. Particularly, line 21 of the VBI is used for the data transmission. In the context of the realization of the TV navigator, HTML data are transmitted by means of the EIA 746 standard. This technology also became commercialized as Showsync or TV Crossover Link. However, the realizable data transfer rates were completely insufficient to realize more advanced TV/web concepts on this basis.

The data within interactive television are transmitted periodically by means of datacasting or over the data carrousel via the receiver or broadcast channel to the receiving client-sided data processing units. The data, which are represented within interactive services, are either already contained in the data carrousel or they are requested by means of the back channel via an external server and transferred via the data carrousel and distributed to the client-sided output devices. Because of the limited transmission resources, in particular, because of the limited capacities on the data carrousel within the receiving channel, the choices of the displayable data are limited and therefore this sets narrow limits on individual choices. The amount or set of the data, which is output and/or provided within interactive services of the receiving channel is limited and is also called “Walled Garden”.

The interactivity is realized within the state of the art technology by operating components, such as buttons or menus, which provides predetermined operations on the client-sided data processing unit with the available data and follows predetermined hyperlinks or program operation procedures, which are transferring data to the server in a predetermined manner.

The known state of the art technology for controlling the interactivity with viewers of TV programs are based on the concept that all controlling data for the execution of an external data request are contained in the received data stream and that it was prepared by the producer of content accordingly. In particular, this is done by inserting trigger. These triggers must be inserted in a disadvantaged manner for all data formats or types separately. This is done by means of different technologies.

Triggers are real-time events, which can be used to realize Enhanced-TV. For instance, ATVEF (Advanced Television Enhancement Forum) uses standard triggers. According to this standard, the triggers contain information about extensions that are provided to users by the server. The triggers are used to inform the user or the receiver of the content that corresponding content extensions can be received from a server by means of a local activation signal. Triggers are transmitted via the broadcast medium as digital, textual data. Besides other information, every triggers contain (at least) one standard universal resource locator (URL), which contains the address of enhanced content. The triggers can also contain textual description data or JavaScript fragments, by which JavaScript can be started within an assigned HTML page and/or enhanced content, and can be synchronized with video content.

A disadvantage of this technology consists of that every new video file effort arises newly, by which interactive services must be adapted via changed control data within the interactive services so that a meaningful interaction takes place with the user.

Within the technology of Enhanced TV different program types like sports, shows or feature films have different assigned data templates, in which buttons, hyperlinks or user-sided activatable areas are contained within the data templates, which contain data that has been determined by the producer of the interactive content before the show has been broadcast.

The viewing of interactive broadcast content that is regarded as too complicated and/or too overloaded because of too many buttons and/or selection options for its use can be seen by the passive viewer, who only wants to be entertained, as already too exhausting. The announced and displayed data do not usually include any data, of how viewers can receive desired data, because the band-width is too low or narrow for interactive services and this bandwidth does not allow personalized functions.

The viewer will consider the interactive supply as unattractive, which is additionally only offered (synchronously) at the moment of the TV program broadcast, since no opportunity or reason exists to watch the many different options of the interactive services within the limited time of the TV program.

The existing interactive TV solutions offer insufficient opportunities for the personalized prioritization and for the server-sided adjustments of the additional data which are offered for the video file and which are corresponding thereto. In particular, the offering of content-related, in particular server-sided, additional data related to video data over the television is only known by means of using triggers.

The problem arises from the use of the data that are offered in the data carrousel and/or on content inserted as data calls that the data from the interactive request cannot be transferred via the data carrousel after the content has been stored on the video recorder and although the viewer wants to watch or to make use of the content dependent or TV program dependent-interactive service at a later time.

Furthermore, another problem consists of that a user who sees video content, is watching a TV show, a commercial or a scene of a video and based on the seen content of this video, he would like to have additional information. Due to the high qualitative and quantitative information density of picture, image and video contents, nobody can in general know in advance what the user is interested in within a video. Therefore, simply inserting or assigning additional content to the video content or the data carrousel is inevitably insufficient.

Furthermore an important problem from the state of the art technology consists in the use of so-called triggers in video content and in the broadcast signal. These triggers are inserted in the video content or in the corresponding VBI and they serve to make users aware about the existence of additional data. These triggers are used to stimulate users to request content by means of URLs or the like, which are provided for these triggers on these servers. The disadvantage of this approach or tactic consists of the missing readiness of the broadcaster or networks, especially for content to which they do not have any further extensive rights, to insert triggers and/or to provide server-sided content. Particularly, a disadvantage consists of the missing reusability of triggers and the corresponding content. These triggers can also be lost within the transmission or it can be filtered out by the hardware deliberately or unintentionally. If the video content will be stored by means of a video recorder, then the trigger is usually not stored, so that interactivity can't be offered or used later on. If the same content shall be output on another platform (for example a PC), then the triggers data, which enable the interaction, may not work and will not be transformed automatically.

In particular from the state of the art technology, no method is known that offers interactivity, which has been assigned to a video once, on different platforms, in a platform-independent manner, in which the interactivity remains invariant or uninfluenced by the data transformation of the video content and depends only on the abilities of the video output device. The flexibility within the data transformation and the retention of the interactivity is particularly important if the output and display of videos (as a result of the digitalization) takes place on differently equipped hardware platforms (SDTV, HDTV, PC, PDA, mobile Phone) and after the storage in different data formats on DVR, PVR or PC.

Furthermore, a general problem consists therein, that no solution offers platform-independent interactive content independently of the video format or independent of the possible output platform for video data. Moreover, there is no method known, in which at any time within the video and/or for the complete video data additional data can be offered, in which without additional expensive post production the owner or editor of the video content can make use of these content data in different embodiments of the video content.

There is also, according to the state of the art technology, no reliable and flexible method to include or assign in already published or distributed content afterwards further assignments such as links or hyperlinks onto other Web servers which offers for example further textual or multi-media content. Therefore, the user of the multi-media content has no opportunity to immediately receive further requested data to the detail aspect and context related to the video content or the scene by means of additional information or additional data.

Hypervideos for instance offer users the opportunity via the activation of mouse-sensitive zones on these spatial and temporal limited or restricted areas within the video output to activate a hyperlink and thereby query additional server-sided information. Thereby, data that are extracted on the client-side are sent to the server and the server is sending data, which are assigned to these requests, back to the client. However the interaction opportunities or options or activation opportunities or capability of a user are inherently within restricted a hypervideo by the data, which are contained in the video, that are used for the initiation and usage of an activation signal.

In another embodiment of hypervideos, such as the solution of the company Empactv, data and hyperlinks, which are available on the client-side, are mapped to different zones of the video output. The initial creation or preparation effort of this mapping is very large and the adding of additional data remains incomplete, because within the creation of the additional data nobody can really know in advance in what a viewer or user of an image is interested in. Furthermore, the creator must pay attention while creating data that the assigned information related to server addresses and their parameters remain unchanged in the future in order to prevent a corresponding error message. Moreover, a viewer cannot recognize which data were connected or provided with additional data or link data. A further disadvantage of this technology consist of the circumstance that additional content such as metadata can only be assigned to the video by the publisher and not via an independent third party. Generally, the effort for the creation of server-side or in the video content contained or assigned additional data is very high, in particular to content that comprises a direct content-related relationship to the displayed video content, so that content-related additional data to video data is the exception and not common.

The additional hyperlinks or the server-sided available additional data can only be created or produced by the original publisher or by the web page programmer of this content and not by an independent third party. Furthermore these methods are very costly and the same video content cannot be connected on the server-side with different information or hyperlinks, which address different target groups.

Moreover, the additional adding of metadata or additional data in existing or available content files is very costly and sometimes even impossible, if the file or the video data is not in the direct access by the editor anymore. Since the content cannot be updated subsequently, these restrictions or limitations are disadvantageous for the usage and/or distribution via the Internet.

A general disadvantage of existing technologies consist of that the content owner or publisher of distributed material or videos doesn't have any direct contact or access and no connection to the content after publication. Furthermore, the user or viewer of the content cannot create a connection from the user or viewer side to the content owner, even if the user or viewer wishes to do this. The close contact between content and the real content owner, indicated by possession, is lost after the publication and therefore also with the possession-related opportunity to make a direct contact with the users or viewers. The creation of a connection, which can contain within it an embodiment, for example the opportunity of communication, can within the known state of the art technology only be recreated with difficulties, in an insufficient and unreliable manner.

The utilization of unambiguous or unique content signatures for server-sided extraction of path data to the address of corresponding reconstruction keys, as disclosed in the invention DE19950267.6-31, is used for server-sided controllable or manageable release of content. Thereby the technology is designed in a manner that additional server-sided stored data are not displayed on the client-side. Additionally the technology is not designed in a manner that further additional data could subsequently be assigned to the content. Furthermore, the additional data contains, according to the present invention, data, which are entirely and mutually independent from corresponding digital content for which the digital signature has been created, and which provide value-added information. On the other hand, the content-related additional data that are used in the present invention are not necessary in order to decode or reconstruct the digital content in a meaningful manner.

Further state of the art technology can be found in the following literature: in the master thesis: “Interaction Design Principles for Interactive Television” by Karyn Y. Lu (Georgia Institute of Technology, May 2005), http://www.broadbandbananas.com/lu.pdf or in “iTV Handbook, Technologies and Standards” by Edward M. Schwalb (IMSC, 2004) or in “Multimedia and Interactive Digital TV: Managing The Opportunities Created by Digital Convergence” by Margherita Pagani (IRM Press, 2003) or in “Interactive TV Technology and Markets” by Hari Om Srivastava (Artech House 2002) or, “The Evolution of TV Viewing” by John Carey (Internet, 2002) http://www.bnet.fordham.edu/careyl/Evol%20of%20TV%20ViewingB.doc or “2000: Interactive Enhanced Television: A Historical and Critical Perspective ” by Tracy Swedlow (Internet) http://www.interactive-pioneers.org/itvtoday3.html.

Definition

In the following text, the term “content” is interpreted or understood as: data, file(s) or data-stream(s), and in particular the actual representation of what the data represents or stands for in a suitable, adapted and/or appropriate display or output medium. The content can be the same, whether or not it is represented in different data records or data formats, where its binary output is represented differently.

In the following text, the term “video” is interpreted or understood as: temporal change of pictures or images. The individual pictures (single images or frames) consist of pixel or by means of which pictures or images are generated from data sets. Digital videos consist of data sets which are transformed into motion pictures or images by means of a video visualization unit. The single images or frames within the video are encoded and/or compressed. The decoding method for the representation of the pictures or images is carried out by means of software instructions within software components, which are called codecs.

A scene is a section of a film or video, which consists of one or several sections that refer to a part of a common action typically within a single location. The extent or scope of a scene of a film is typically determined by the change of location or by the arrangement or composition of shown objects, materials or actions.

Complete or entire pictures or images within videos are called frames. Pictures or images, which are represented or displayed within a video, are calculated and/or interpolated by means of differences or interpolations or mathematical methods. In the following text, the term “video frame” is used to represent a “snapshot” or freeze frame or a frame or a calculated and displayable picture or image from a video/audio stream (or its corresponding data stream) or audio/video file.

In the following text, the term “video data” is used to represent audio/video data or data which are transmitted or sent by means of TV or which are played by a video recorder or from a video file.

The backward channel is a data transmission means, which can either be a bidirectional electronic network or a unidirectional connection, in which the client is the transmitter and the server serves as a receiver, and in which the requested data are received by the client via the receiving channel of the client.

Term data or category names are names and/or key concepts or key terms and/or a composition of features which are understood as the identical features in objects and facts. Term data can be words or a composite collection of words in the form of a phrase or an expression. Terms can be synonymous, in which different words are representing identical concept/terms or they could be homonyms, in which one word can stand for different concepts/terms. In addition, terms can represent general concepts or terms, in which different, individual objects can be combined with regard to their common features or they can represent individual terms if they describe individual objects or persons which arise by variations of single features and/or over certain time periods.

Description of The Solution

The purpose of the present invention is to create an apparatus for client-sided requesting, transmitting, receiving, delivering, representing, outputting and displaying of server-sided stored data as set forth in the classifying portion of Claim 1, in which server-sided content-related or content-specific additional data are requested via client-sided requests based on client-sided displayed or output data via corresponding content identification data and/or time index data and/or signature data and in which these additional data are received and displayed on the client-side.

The objective is achieved by the apparatus with the features of Claim 1; in particular, all features that are revealed in the present documents shall be regarded in arbitrary combination as relevant and disclosed for the invention; advantageous development of the invention is described in the related, dependent Claims.

In a manner according to the invention, the client-sided requesting, transmitting, receiving, delivering, representing, outputting and displaying of data occur on electronic data processing units, which typically are a PC or a set top box. The audio/video data will be received by a broadcast unit via a unidirectional or bidirectional (like the Internet) receiving channel. Data, which are created or extracted on the client-side, are transmitted by means of a backward channel to the server unit.

In particular, the receiving channel is a unit for the reception of data cable, satellites or terrestrial or aerial, in which signals are decoded in the reception unit or receiver of the set top box or in the TV card, in which the transmission of the data is carried out in an analog manner or in a digital manner by means of known transmission protocols like DVB-T, DVB-S, DVB-C or ATSC or the like.

The reception of data can be done also by means of a data transmission means from a client-sided available storage medium, such as a video recorder, DVR, PVR, or hard disk of a PC or the like.

The data processing unit comprises a representation or output device or unit, in which audio visual and/or further additional data, in particular electronic documents, i.e., streams or files can be displayed or output, under which also the following should be understood: text, picture(s), image(s), music, video(s), animation(s) or software-based application(s). The audio visual and/or electronic documents are represented, displayed, output or played in the document representation or output device or unit or in some other digital visual, video or audio visualization/output/representation unit.

The visualization/output/representation unit can be assigned to a program operating environment or system, which makes the access to data within the represented document possible. In a preferential embodiment, the document output unit is a TV monitor, PC monitor, a mobile PDA, phone display or an audio visual media player or a Web browser or an output device of a content editor.

The functional unit is assigned to the electronic data processing unit or contained therein. The functional unit is able to access the audio visual and/or electronic document. Furthermore it is suitable and adapted to send data via a backward channel, which can be realized in a bidirectional manner, and to receive data via the receiving channel or the backward channel. The functional unit is software or a program which runs on the electronic data processing unit on the program operating environment or system or on the middleware or on the operating system. The functional unit can alternatively be realized as a separate hardware or as a circuit in a CPU or microprocessor. Additionally, this functional unit can be sent by the transmitter via the receiving channel, and it can via the data carrousel or the like, be downloaded or transferred with the audio visual data by means of datacast or the like, and can be executed in the program operating environment or system, or as direct or indirect instructions for the CPU.

The functional unit can be activated at every time by means of an activation signal, particularly if audio/video data are output or represented in the accompanying output device, by means of an assigned activation unit, which is assigned to the data processing apparatus. The activation unit can be a button or an activatable area in the visualization/output/representation unit or a function not visually displayed or denoted which is activated or triggered by a user in a known manner by means of mouse, keyboard or remote control.

The activation of the activation unit is done in a temporal, spatial and/or logical relation or correlation with the viewing of video data or the TV program by a viewer or by the use of video data or the TV program by software instructions that are initiated by a user within the data processing unit used by the user. From the viewpoint of time, the activation refers to a video frame, which is displayed, output or used within the display, output or usage of the video data. The video frame that is used or determined by the activation of the activation unit can be calculated by means of data, parameters or instructions. In particular, those data could be contained in the functional unit or in the metadata as additional data and thereby a video frame or a quantity or amount of video frames, which is different from the displayed video frame, can be selected by means of the activation unit. With the activation of the activation unit, the functional unit uses the extracted data which are part of or assigned to the select video frame or the set of video frames.

According to the invention, the functional unit can be assigned to or can comprise a time index data creation or extraction unit, from which additional data can be extracted from the audio visual content or from service or format information that is assigned to video or TV content. The data can be extracted from the video frame or from the previous or following video frame that is chosen in a predetermined manner and/or displayed or denoted by means of criteria while the functional unit receives the signal of the activation unit. The extracted or generated data form or create time index data, which comprises an assignment or relationship, in particular a unique assignment or relationship, to a relative or absolute moment or to a time interval within the outputting or displaying of the audio visual content in the document visualization, output, or representation unit, in particular at the moment at which the activation unit is activated. In the following, the data are called time index data or time codes. The functional unit can contain the time index data creation or extraction unit or it can be separated from it. In the following, if a feature is called separated, then this can also mean physically separated or logically separated or spatially separated.

Furthermore the functional unit can comprise a content identification unit or metadata extraction unit, by which the marking, labeling, tagging or identification data and/or metadata for the displayed or output audio visual content or a temporal section of the content, such as a scene or a video frame, can be identified and/or extracted and/or generated. Video frame based and/or content-based identifiers or metadata and/or of this content, extracted or generated additional data for the identification of audio-video content, in particular content or scenes or video frame-dependent description data, are called in the following marking, labeling, tagging or identification data. The functional unit can contain the content identification unit or meta-data extraction unit or can be separated from it. In the following, the content identification unit or metadata extraction unit is also called the identification data extraction unit.

Furthermore the functional unit can extract or generate data by means of a signature data unit which are in a unique relation to the video frame. The functional unit can contain the signature data unit or it can be separated from the signature data unit. The signature data, which are extracted or generated, or fingerprints are calculated by means of mathematical methods from single video frames or from a set of video frames. The signature data unit can extract data from the video frame-dependent or scenes-dependent signature data, whereby in the following text these are called signature data. The signature data can be assigned to a single video frames and/or to a set of video frames, such as a scene, or to the complete content. The data, from which the signature data can be extracted as metadata, are binary or ASCII based. These data can be extracted by means of a compression method or data transfer method. Furthermore these signature data can be stored within the metadata in an encrypted manner.

The functional unit can be regarded as a combination of technical units or it can be regarded as a technical unit that uses technical means for the coordination between the units and/or that determines, provides or comprises technical or information technology interfaces between the components.

The functional unit or its contained sub functional units don't use triggers, which might be available or assigned within the audio/video content available. In particular, the functional unit does not use triggers, which are used to invite users to activate link data (URLs) that are contained in the triggers.

The activation signal from the activation unit initiates or starts by means of the functional unit in a predetermined manner forming or creating the time index data and/or marking, labeling, tagging or identification data and/or signature data so that by means of the time index data and/or marking, labeling, tagging or identification data and/or signature data related to a video frame created at the moment when the video or TV program is watched while the activation unit has been activated. By means of the mentioned data and or by means of the corresponding data relationships, the mentioned content-dependent data can be determined. The functional unit can contain the activation unit or it can be separated from the activation unit.

Furthermore the functional unit is comprised of an assigned or corresponding transmission unit, which is designed and/or adapted for the transfer, in particular for the separate transfer time index data marking, labeling, tagging or identification data and/or signature data and/or configuration or preference data from the program operating environment or system by means of a backward channel from the client unit to the server unit. The data are transmitted or transferred in a known manner by means of the widely available and standardized communications protocols like TCP-IP, UDP, HTTP, FTP or the like to the server unit, in which the server unit is an application server, file server, database server or Web server, and in which within the server after transmitting in a known manner requesting and/or resourcing, supplying, stocking or provisioning instruction or operations will be triggered. The functional unit can contain the transmission unit or it can be separated from the transmission unit. The data transmission can also happen by means of or within a proprietary transmission protocol such as by means of an order system for Video-on-Demand content.

In the server unit after the reception of the data and the processing and/or analysis of the received data, predetermined and/or assigned server-sided additional data are assigned or calculated, by means of a server-sided assignment, classification or correlation unit provided for the transfer or directly transferred to the client.

The server-sided additional data are preferably content-related or content specific additional data, which refer to the content of the video content. In particular the additional data relate within the content-relatedness to the relationship of the video frame content to the video frame handled or displayed object(s), animal(s) or species of animal(s), plant(s) or species of plant(s), product(s), trademark(s), technology, technologies, transportation means, machine(s), person(s), action(s), connection(s), relationship(s), context(s), situation(s), work(s) of art or piece(s) of artwork, effect(s), cause(s), feature(s), information, formula(s), recipe(s), experience(s), building(s), location(s), region(s), street(s), environment(s), history, histories, results, story, stories, idea(s), opinion(s), value(s), explanation(s), and/or rationale(s), reasoning(s) or the like with corresponding information, which can be comprehend in these categories or included in these categories or themes.

Furthermore in a reception unit or receiver assigned to the functional unit, which are sent from the server to the client or received by the client or received by client-sided, downloaded additional data and processed and or output by the preparation unit for the output, in which the output device and the audio/video data and data visualization/output/representation unit can be identical in an embodiment of the invention and can be separated in another embodiment. The functional unit can contain the reception unit or receiver or it can be separated from the reception unit or receiver.

The reception unit or receiver for additional data receives the server-sided, additional data via the back channel or via the video receiving channel or via the Internet or via an arbitrary proprietary data transmission network. The back channel can consist of a unidirectional or bidirectional electronic data transmission network.

In another embodiment of the invention, the reception unit or receiver for the additional data is present on a separate data processing unit, in particular, separate from the functional unit, and/or can be displayed or output on a separate visualization/output/representation unit.

Preferably, the marking, labeling, tagging or identification data, which are extracted by means of the activation unit and the corresponding extraction unit at a moment in time or during a time interval, can describe, characterize and assign on the client and/or server-side the output or distributed audio/video data or a component or portion of the output or distributed audio/video data or displayed or output scene or extracted video frame(s).

The marking, labeling, tagging or identification data can consist of the following components and/or be able to be assigned to these marking, labeling, tagging or identification data by means of data relations: description, designation of the TV channel in particular, TV channel name or description, TV channel number, geographical or regional location of viewers, name or designation or region of the cable network, or name or designation of the satellite or TV provider, data for the description of the TV program, or of video data, such as for instance the program name or the program number, name of a scene, or number of a scene, or additional digital symbol, mark or sign, which are within the teletext data area or within the VBI signal or contained within the data that are transmitted in the electronic program guide (EPG) with the audio/video data, or which are included or assigned within the service information or format information of the digital TV norms or standards or added to and/or contained in the video formats and/or in separately introduced program and/or broadcast-tag or label, which can be used in the form of arbitrary metadata or identifier data. These metadata and identifier data can be used on the client-side by the visualization/output/representation unit or by the data processing unit as an assignment for additional data. The marking, labeling, tagging or identification data can consist of arbitrary combinations of the above-mentioned data. In addition, the assignment of client-sided extracted data to marking, labeling, tagging or identification data can also be done on the server by means of table and/or by means of an algorithmic assignment.

Furthermore, client-sided marking, labeling, tagging or identification data can control the selection process by means of supplemental, additional or metadata, in order to get the video frame which represents the scene or the sub-scene that can be selected by means of additional server-sided or broadcast-sided parameters.

In another embodiment of the invention, the time index generation or extraction unit extracts the video frame from the video data which consists of a plurality of video frames which was displayed at the moment or within a predetermined time period of activating the activation unit or which represents the scene or sub-scene by means of supplemental data or metadata or which was selected by means of server-sided or broadcast-sided parameters. The time index data creation or extraction unit extracts the time index data from a plurality of assigned or corresponding service information data and is creating in particular video frame related index data. The video data can be designed or created according to a DVB and/or an ATSC norm and contain additional service information, which is provided by the according DVB-SI or an equivalent ATSC norm and the time index data, which are contained therein, and can be extracted by means of the time index data creation or extraction unit.

In another embodiment of the invention the time index data are values from a linear time scale, which is assigned to the output or displayed audio/video data or they are data inside or within the audio/video stream, which are inserted, assigned or extracted by means of watermark or equivalent mathematical methods within the video data or within the metadata or description data added to or assigned to the video data or the video frame. The time index data can also consist of values which comprise a predetermined algorithmic and/or uniquely determined assignment on the moment of the activation of the activation unit or functional unit.

In another embodiment of the invention, the program or the channel characterizing marking, labeling, tagging or identification data or the above-mentioned embodiments of the marking, labeling, tagging or identification data of the transmitter or broadcaster in the audio/video content and/or the assigned service or format data are inserted and/or directly transferred from the transmitter to the server.

In another embodiment of the invention the functional unit extracts data by means of a signature data unit which is in a unique relationship and/or assignment to the video frame which was displayed or output during the activation of the activation unit or the functional unit at the video output. These signature data or fingerprint data are calculated by means of mathematical methods, in particular a hash method or a digital signature or a proprietary picture or image transformation method, by means of a single video frame or by means of a predetermined set of video frames. The signature data can be calculated in a manner, so that they are invariant with respect to transformations, as they appear while storing in different picture or image sizes (such as JPEG, GIF, and PNG etc.).

A hash value is a scalar value which is calculated from a more complex data structure like a character string, object, or the like by means of a hash function.

The hash function is a function that generates from an input of a (normally) larger source data or original set or quantity a (generally) smaller target set or quantity (the hash value, which is usually a subset of the natural numbers).

Electronic or digital signatures or digital fingerprints are electronic data, which are calculated from digital content. With known fingerprint algorithms such as MD5 or SHA-1 the change of a single bit can lead to the change of the digital fingerprint. With more insensitive fingerprint methods the change of several pixels can lead to the same signature or to the same fingerprint. Preferably within the context of this invention is the usage of an insensitive signature or fingerprint algorithm.

Picture element data are data which are used to define images, for instance pixels or the like, and/or they are data that can be used to identify images, for instance thumbnails of images or digital signature data or digital fingerprint data or the like, and/or they are data that can be used to determine video frames within a context, in particular within video data, as for instance with unique names or identifiers of video data and the serialization of video frames within these video data or to the moment of the appearance of the image as the video data plays and the value of a mathematical hash code of the video image or of the video frame correlated or assigned GUID (Globally Unique Identifier or Global Universal Identifier) or the like.

A hyperlink is a data element that refers to another data element by means of which a user can access data or can get data transferred if he activates or follows the hyperlink. Hyperlinks are realized by URLs, in which an (IP) address of an (in particular external) server and a path or a parameter list is contained, which is applied or executed on the (external) server in order to extract and/or to assign data.

At the use of signature data all audio video data must, to the context specific and/or video content or video scenes specific and/or assigned additional data server-side are made accessible by means of signature data, before the use; all signature data belonging to the video data are shown by a viewer, a server, which is called in the following video index servers.

The initial process of transferring video-content related signature data on the video index server is called in the following as a video or content registration. With the content registration all signature data related to the video data are sent to the video index server and are put down in an index so that the individual signature data can be found faster. With the registration of video data, corresponding additional data, such as title, description of the video data, project number, URL or the like are transferred and/or stored on the video index server. The video index server can either receive the signature data or convert the video data into signature data on the server. After the registration of the signature data, the user or the viewer of the video data can request the additional data by means of the signature data.

The data, which are stored as additional data related to the signature, can consist of a URL, which redirect the user automatically by means of the client-sided or server-sided data processing unit. Additionally, the additional data can be web pages with text, picture(s), image(s), video(s), script(s) (active—in particular exportable code) or interactive element(s), such as menus or text edit boxes or input field or the like.

The signature data, which are created on the functional unit, are searched in the server-sided video index. If the data set is found, the corresponding information can be extracted from the database and can be sent to the client. The video frame that is used for the signature data creation can be the video frame that was displayed or output during activation of the activation unit from the video data or which was displayed or output before or afterwards within a predetermined period of time or that was selected by means of additional metadata or server-sided or broad-cast-sided parameters on the client-side by means of the functional unit. The signature data unit can also extract signature data directly from the description data, in particular within the video frame or from the assigned metadata, whereby the extracted signature data are in a unique relationship or correlation to the video frame, which was selected by the user or it is in relationship or correlation to the metadata or description data of the video frame, that is in relationship or correlation to the selected video frame.

The assignment on a time date or on a relative time date (within the video data) at which the activation unit has been activated, can also be done in the server unit by means of a table and/or an algorithmic assignment. The assignment can also be done on a time interval. In this embodiment of the invention, the time index creation or extraction unit extracts a time code or identifier data or time index data from the audio video data. Alternatively, by means of the marking, labeling, tagging or identification data extraction or generation unit, identification data can be extracted from the video data or from the additional data that are related to or contained in the Video and/or by means of the signature data unit, signature data could be extracted and/or generated so that resulting from the or after the generation of the functional unit at least one of the mentioned values or predetermined combination of the mentioned data can be transferred by means of the transmission unit to a first server unit. By means of assigning or extracting or calculating the name of the content and/or the time of activating the activation unit or a relative time or a relative time interval, with respect to the relative beginning or start of the video data, can be created, extracted or calculated. The calculation of the time date or the time interval, in which the activation unit was activated by the user, in particular with respect to the video data, that were seen or displayed at the same time, is in a direct relationship to a scene of the video data that was watched by the user. This relationship then can be determined, assigned or calculated on the server-side. Additionally, the functional unit can send additional data, such as configuration information/data or preference data of the local program operating environment or system together with a combination of the above mentioned data, to the server, whereby the server uses these additional data in a predetermined manner to adjust the server-side output of data to these data and to modify or to create them.

Additionally, in another embodiment of the invention, the names of the TV transmitter and/or TV program and/or the video and/or the topic of the video or TV program and/or the genre of the video or TV program can be extracted, calculated, assigned and/or generated on the server-side from a limited number of marking, labeling, tagging or identification data and/or from the signature data of the video and/or TV program data. The data which are extracted, generated and/or assigned on the server-side by means of marking, labeling, tagging or identification data or signature data are called server-sided theme or term data or content-related or content specific additional data. Via the different video data, which are sent by a transmitter, different server-side theme or term data can be assigned to the marking, labeling, tagging or identification data and signature data within the content of a transmitter or also within the time of playing a video.

The theme or term data are taken from a set of names, terms, concepts, topics, data, addresses, IP addresses, URLs, menu names, category names, to textual ideas of equivalent pictures, images or symbols or the like. In particular, theme or term data can be reduced on the server-side within a transmitter or a program or a video, by means of a time data or a time period data or a combination of the mentioned data, to content-related data of a scene, which a user is watching on a client-sided visualization/output/representation unit at the time or within the period of time of activation of the activation unit. On the serverside, theme data can be selected, filtered, reduced, categorized and/or prioritized by means of choice and/or filter and/or categorization and/or prioritization algorithms.

In another embodiment of the invention the identification value can be inserted by the transmitter into the TV transmitter or into the TV program by means of format or service information within the digital content and/or it can be transferred directly to the server unit or it can be requested by the server and/or it can be assigned to the marking, labeling, tagging or identification data in a client-sided or server-sided manner.

The marking, labeling, tagging or identification data or data that are contained in the content can be used directly for the determination, creation, or extraction of the address of the server unit. Alternatively the functional unit can contain a predetermined address, in particular an IP address or a URL, which is used to transmit data to the server that is determined by the address by means of the assigned transmission unit. In another preferred embodiment of the invention, the first server unit, which receives data of the functional unit, is a server, which provides a list of server addresses. The functional unit receives a server address (URL) from this server, which are assigned in a predetermined manner with data, which have been sent by the functional unit to the server. The functional unit then transmits a predetermined combination of marking, labeling, tagging or identification data, time index data, signature data like server-sided additional data which are received by the first server unit and additional client-sided data which are managed by the local program operating environment or system to the second server such as configuration information or preference data and receives data which are suitable for the client-sided outputting, displaying or representation or further (data) processing, which is transferred for the direct client-sided output or display.

In another embodiment of the invention the server is informed about data which are used by the server in order to provide the transfer of the displayable additional data for the video data, which is watched by the viewer. In particular, the client-sided additional data are used to deliver the user of the output device adapted output data and format and layout data or data which are adapted to the client-sided hardware configuration.

The activation unit can be a manual means for the triggering of a signal that is subsequently, immediately, or with a delay, triggering actions in the functional unit or in the means that is producing or creating signature data, time index data or marking, labeling, tagging or identification data, and which is assigned to the functional unit. The manual means for triggering the signal can be a usual remote control and/or a keyboard and/or a mouse and/or a PDA and/or a Mobil Phone and/or a button directly at the television and/or at the set top box and/or a touch sensitive area on the screen or the like.

The input of the activation signal can happen during the output or displaying of the video data at an arbitrary moment. The input of the activation signal is independent of metadata that might be contained in the video data, of format data or of a predetermined feature or a predetermined processing of the video data.

In a preferable embodiment of the invention, the first server, which receives data of the functional unit, comprises a video index directory, in which video-related signature data are stored and by means of an index are made searchable. In the following, this server is called the video index server. The data that are contained in the video index list or directory created with the same or equivalent methods as the signature data are extracted or generated on the client. The methods are equivalent if the distributed results are the same. The video index server stores signature data or video index data for a video or for a TV program in which these signature data or video index data were produced or created according to a transformation method or to a hash method from the video frame and/or from the corresponding content. Additional information, which is stored with the video index data, contains additional data, in particular address data or IP address information from servers, which contains further displayable information that can be called and can be displayed. The video index server can receive data from the transmission unit, which is assigned to the functional unit, and which is finding content-related data by means of the video index and which provides data to be received by or transmitted to the client.

In another embodiment of the invention the server-sided additional data can consist of address data such as IP address, URL or the like or from not displayable instructions to the functional unit or software component and/or hardware component that are assigned to the function unit by means of which the transferring instruction data or configuration information are executed on the corresponding software component or stored by the hardware unit and/or direct, immediately or timely delays.

Server-sided additional data can comprise or provide user activatable choices, menu bars or activatable options, which are equipped with hyperlink(s) and/or with text, metadata, picture(s), image(s), video(s) or the like. In the simplest version, the user activatable options or choices can consist of a plurality of text data and/or image data and/or hyperlinks.

Server-sided additional data can comprise or provide user activatable choices or the plurality of text data and/or image data and/or hyperlinks and can be displayed in the audio/video and data visualization/output/representation unit and/or in a separate or remote output device.

According to the invention the not finding of specific signature data received from a viewer within the video index can be answered by the server with a standardized set of additional data.

These additional data can also consist of a text and picture message. Alternatively, a URL can be sent, which redirects the user to another web page or to another web portal. In another embodiment of the invention the marking, labeling, tagging or identification data, such as the name of the video or the related sequential of (or number within) a video series, result, that the data request is being answered by means of redirecting to a server which is a dedicated web server or web page related to said video. If the time data of the activation, in particular relative to the beginning of the video, can be extracted and/or can be determined on the server-side, then also scene-dependent additional data can be extracted and corresponding data prepared on the server for the download or for the supplying, provisioning or stocking.

In another embodiment of the invention the marking, labeling, tagging or identification data, such as transmitter name or channel number, together with time data or time period data, which are derived from the time index data, can extract the name of the video and/or the series by means of a data request in the electronic program guide (EPG) and transfer to the user additional data, such as a corresponding URL or the like, which are related to the contents of the video.

According to the invention the receiving channel is a channel for the reception of an analogous and/or digital television by means of cable, satellite or antenna in particular via terrestrial television. The receiving channel can also be the Internet, WLAN or a (wireless) phone network system.

According to the invention the functional unit can, by means of a content signature unit, create, produce, generate and/or form a plurality of unique digital signature data of the video contents, which are extracted from a video displayed in an output device via its corresponding content data and/or of the video frame or of a plurality of video frames.

According to another preferred embodiment of the invention, the digital signatures or the signature data can be hash codes which are formed by or created from the electronic content file directly or after a filter or a data converter has been applied.

The digital signature can dependently or independently from the data format make use of the grey or color values distribution of the pictures or images in order to distinguish data or files from each other uniquely; in addition, the digital signature data can also be used to recognize or identify similar pictures or images automatically or to calculate distances between images by means of the digital signature data and by means of an order relationship to find similar images via database access efficiently. In this digital signature file format value can also be contained such as image sizes or compression method in order to gain a quick unique distinction between different data or files.

Preferably, the digital signature can be created in a manner that the corresponding signature data of content data, which have been stored after conversion in diverse or different output formats, and which have been derived from a common source, shows a very high conformity via signature data, such that even content files with diverse or different formats can automatically and mutually be identified via signature data.

The electronic signature data is used in the server-sided signature-data-to-additional-data relationship unit to select and/or to determine and/or to calculate additional data, which are stored and assigned via relationship therein. The additional data, which are associated with a particular digital signature, are sent from the server to the function unit where they are displayed in or via the document-visualization/output/representation unit. The additional data can also consist of addresses, IP or URLs and the client-sided functional unit can be used for another server-side data request, so that the data are provided for the client-sided output by these other (further) servers.

The content, for which the content signature data are formed or created, are invariant with respect to the server-sided additional data. The server-side, in particular content-related additional data, does not change the content that is related to the signature data and they are also invariant with respect to data transformations or changes in the used video format or video codec. The additional data are preferably adapted to be output in the client-sided visualization/output/representation unit or as a hyperlink to provide a link with further resources.

In another embodiment of the invention registered signature data of a predetermined codec or format of video content that is transformed into video content of another content codec such that corresponding signature data can be inserted as alternative values of the original signature values.

The server-sided additional data can preferably be represented or displayed by the visualization/output/representation unit, which is assigned to the client-sided functional unit or in an independent window or screen or it is reprocessed or further executed by the functional unit or an assigned software or hardware component as a data set.

The server-side additional data are preferably data in which user activatable options or choices are provided. These options or choices, which are activatable by users, consist of a plurality of displayable text data and/or image data and/or multimedia data and hyperlinks. In another embodiment of the invention, these hyperlinks are activated manually by the user, whereby the client-sided activation data, which is as a data set or as a plurality of data sets, are transferred to the server unit, and in which these server units other predetermined server units are transferring further additional data to the client. The data, which are transmitted by the client-sided functional unit to the server, like in another preferred embodiment, the content signature data are contained, which are stored on the server, together with the client-sided selected data, such as category or topic names, theme names, in the signature additional data relationship unit.

In another embodiment of the invention, movies or videos can be divided or separated into scenes, whereby a scene consists of a connected set of single images or video frames and scenes can be assigned to a plurality of content-related additional data.

The electronic data processing unit can contain or comprise a converting, transforming or conversion unit or transformation unit for a digital television, in particular a set top box that is separate from the television set. The electronic data processing unit, in particular the personal computer (PC) can be equipped with an analogous and/or digital TV tuner card, which is operating as a receiver module for the reception of television. The Mobil Phone or PDA can be equipped with a TV receiver unit.

The functional unit can be realized or equipped with middleware which is realized or equipped as a program, operating environment or system in the electronic data processing unit. In a concrete embodiment, the middleware can be realized for or consisting of MHP, OCAP, Microsoft Foundation edition, or OnRamp.

### BRIEF DESCRIPTION OF THE DRAWINGS)

Further advantages, features and details of the invention will be apparent from the following descriptions of preferred embodiments and with references to the following drawings:

FIG. 1: a schematic image for the client-sided request, query, assignment and display of server-sided additional data

FIG. 2: a schematic block diagram for the method of client-sided request, query, assignment and display of server-sided additional data

FIG. 3: a schematic image for the client-sided request, query, assignment and display of server-sided additional data by means of an assignment, classification or correlation unit

FIG. 4: describes a concrete sequence of operations for the methods to operate a device, according to the invention, in particular of the system as described in FIG. 3

### DETAILED DESCRIPTION OF THE INVENTION

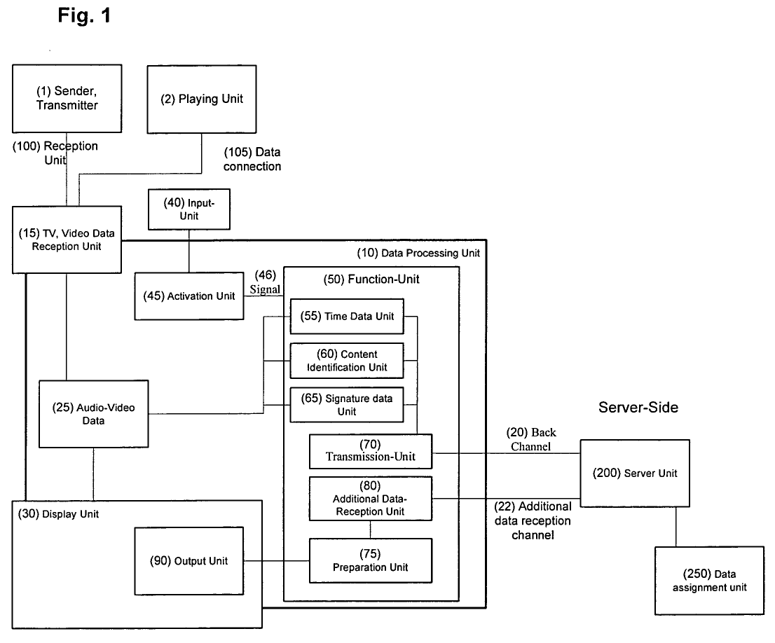

FIG. 1 describes a schematic image for the client-sided query, assignment, receiving and representing of server-sided data which comprises a client server system that is connected by means of a receiving channel (100) and a backward channel (20), which consists of the client-sided electronic data processing unit (10) and the server-sided server appliance (200).

A transmitter or broadcaster (1) sends audio/video data (25) via a receiving channel (100), which can in a concrete embodiment, be a cable, satellites or terrestrial transmission means to a client-sided data reception unit or receiver (15), which can convert the received data so that the data are suitable or adaptable to be displayed in the visualization/output/representation unit (30) and/or can be displayed in or output by the device of the visualization/output/representation unit. The output or displayed audio/video data consist of single images or video frames. The visualization/output/representation unit (30) or the data reception unit or receiver (15) is a TV or video capable television, in particular by means of a digital set top box, which is capable to display digital videos, in particular capable to output, display or play videos, which are encoded as MPEG 2.

Alternatively, video content can be delivered from a client-sided, available display or playback unit (2), such as a video recorder, DVR, PVR or DVD or HD-DVD or a hard disk of a PC or the like, or a data stream. The data provided by the storage medium (2) will be transferred to the reception unit or receiver (15) by means of a data connection with the TV and video.

By means of an input unit, for instance a mouse, keyboard or remote control (40) a user can trigger an activation signal (46) in an activation unit (45). The activation unit can be, in a simple embodiment, a button of the remote control of a set top box (STB) or mouse-activatable areas provided in the visual user interface of a PC. The data input is connected with the input unit (40) outside the data processing unit (10).

The activation signal is being sent via functional unit (50) defined by the program sequence of an operations environment to the time index data unit (55), to the content identification unit (60) and/or to the signature data unit (62) in order to provide or enable and/or trigger these units to access to the audio video data, in particular on the binary video content and the metadata and/or service information and/or format information, which are assigned to the content.

In the simplest version, the time index data unit (55) can extract the time data that are contained in the data. Due to the encryption of digital content the single video frames have no added time code information, in order to make the deciphering of the protected content more difficult. Instead, a time code can be added or included in this content within the textual additional data and by means of corresponding identification, tagging or marking; the time index unit (55) can extract this time code. Because time index data are not enclosed in every video frame, the unit (55) is generally not extracting the time index data of the video frame that is displayed at the time of activating the activation unit. Instead, the time code is used, which was contained as a last entry within the data record and/or which are received by the transmitter next. The exact moment of the activation can be determined with the time index data creation unit by means of the timer that is contained in the processor and thereby the time period between activation and appearance of the data can be measured and this difference can be added to the known time value.

The content identification unit (60) extracts textual data contained in the video content, which are contained in digital form as a broadcast tag or label and/or as a program tag, label or mark. These data are included in digital television (DVB) within the service data or format data. A program operating environment or system, as it is contained in a STB by means of middleware, is able to isolate these values by means of a data extraction in a predetermined manner.

The signature data unit (62) extracts a video frame from the audio video data. The extracted video frame can be the image that was displayed or created by the video data displaying or outputting unit (15) at the time in which the activation signal was created by a user. By means of the signature data unit (62) the fingerprint algorithm is executing the data processing of the extracted video. First within the color normalization or standardization the color scheme error found is corrected by means of a color histogram technique which reduces the color scheme errors in a predetermined manner. A subsequent grayscale calculation or computation for all pixels leads to a grayscale image. Subsequently, via averaging (mathematical average value creation) over all pixels, in which pixels are assigned to one pixel after reduction in the size of the thumbnail, the thumbnail will be calculated. The thumbnail has a size of 16*16, whereby this is reduced linearly from the original picture to the thumbnail. The limits or borders of the area, over which pixel values are averaged, arise from equidistant width and heights. Considering the 16*16 size of the thumbnail, the pixel width of the picture and the pixel height of the picture must therefore be divided by 16. The fractions of a pixel between adjacent areas have to be considered in the averaging as a fraction accordingly.

Alternatively, the fingerprint can be delivered within the content as enclosed corresponding textual additional data, and by means of a corresponding identification, the signature unit (62) can extract these signature data or fingerprint from the additional data that are contained in the content. Since the signature data are not enclosed in every video frame, in general, the unit (62) does not extract the corresponding fingerprint related to the video frame, which has been displayed at the moment of activation of the activation unit. Instead, the signature data could be used which were contained in the data and/or are or were already or will be delivered. The exact time data related to the activation can be determined by the signature data creation unit via the timer that is contained in the processor and via measuring the time period between activation and appearance of the corresponding data and by sending this difference with the fingerprint or signature data to the server.

The time index data, marking, labeling, tagging or identification data and/or signature data, which are delivered by the units (55), (60) and (62), are transferred to a client-sided transmission unit. The data are transferred to the server by means of a back channel (20) which can be an Internet capable network as well.

On the server side (200), the received data are assigned to content-related additional data by means of a database. This assignment can, by means of the data that are contained in time index and marking, labeling, tagging or identification data, can contain data on the server-side, via data that are stored in the database and that are used to describe the video or TV program, being assigned to this video or TV program. Alternatively by means of time index and marking, labeling, tagging or identification data the assignment can also be referred to a scene, such as to video frames on the server-side. Alternatively by means of the signature data a video frame that is assigned to a signature can be found. In each of these cases, the transmitted data can be associated or assigned with video data or with scenes data. Since the data assignment or relationship unit (250) enables an assignment from scenes to term data and from term data to link data or to additional data, the server unit (200) can provide video content-related additional data as a response to its data reception.

These content-related additional data will be transferred by means of the Internet capable network or data transmission means (22) that is assigned to the transmitter by means of additional data to the additional data reception unit or receiver (80).

For instance, the server unit (200) can transfer the additional server-sided data by means of the data and/or object carrousel, which is sent within the video data, and transferred via the receiving channel (100′) to the additional data reception unit or receiver (80), which is assigned to the functional unit (50).

The received data are then processed by the client-sided data preparation unit for the client-sided output or display in the output device (90). The visualization/output/representation unit (30) is normally a visualization engine that is contained in the middleware of the data processing unit which in particular can be a Web browser. Alternatively, the Web browser can be downloaded from the data carrousel and instantiated on the STB before the reception of the additional data. The video content (25) can, within the output or displaying of the additional data, be managed and/or displayed or output by the visualization/output/representation unit (30).

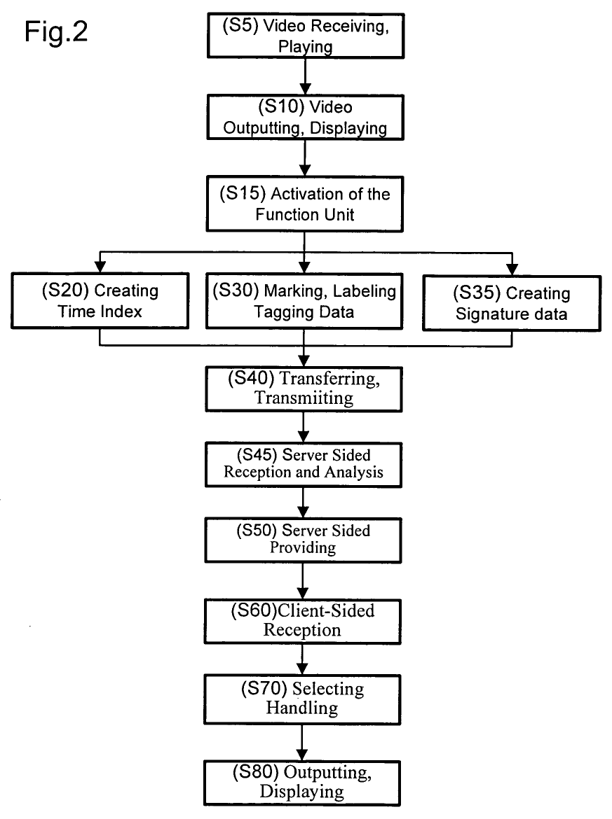

FIG. 2 describes a method for the client-sided requesting, transferring, receiving and displaying or outputting of server-sided stored data by means of a method that is described by the following steps: Audio/video data (25) are received (S25) by the reception unit or receiver and displayed or output and/or distributed (S10) in the visualization/output/representation unit (15) or (30). The user activates the functional unit in the process step (S15) by means of an input unit (40) and/or an activation unit (45). Subsequently, the time index data (S20) and/or the content characterizing marking, labeling, tagging or identification data (S30) and/or the signature data (S35) are formed, created or extracted. The time data and/or characterizing marking, labeling, tagging or identification data and/or the signature data are then transferred to the server (S40). On the server, the corresponding server-sided additional data are analyzed (S45) after the reception and the data that are found in the data assignment or relationship unit are provided (S50) and transferred to the client. The server-sided additional data are received (S60) by the additional data unit (80) and processed (S70) in the preparation unit (75) and displayed or output (S80) in the output device (90).

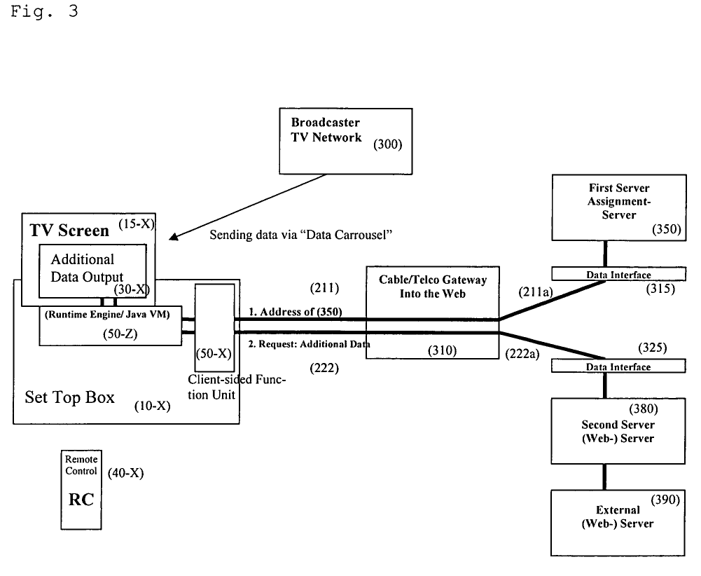

FIG. 3 describes a device for the client-sided query, assignment and displaying of server-sided additional data by means of an assignment, classification or correlation unit.

The client-sided set top box (10-X) receives video data (25) from the TV broadcaster (300) and is displaying them on the TV screen. The set top box comprises a runtime engine or Java VM (50-Z) by means of which executable programs can be executed on the set top box. According to this embodiment the executable programs are transferred by means of the data carrousel that is transmitted or broadcast in parallel the video or TV program. In particular, a Web browser and/or the units, according to the invention, in particular the functional unit (50-X) with the time index data unit (55), the content identification unit (60), the signature data unit (62), and reception unit or receiver (80) and the data preparation unit (75) can be transmitted over the data carrousel (70).

With the activation by means of the remote control (40-X) time index data, marking, labeling, tagging or identification data, which are characterizing the video content, and/or signature data are extracted or generated in the functional unit (50-X). The functional unit (50-X) is connected to the Internet by means of the gateway server (310) that is operated by the cable or satellite operator.

The functional unit (50-X), which is contained in the STB as software, can access the assignment, classification or correlation servers, which are global and/or operated by the operator of the STB and or by its owner, in particular if the functional unit (50-X) is not transferred by means of the data carrousel.

This assignment, classification or correlation server (350) can be operated by the gateway operator. Alternatively, the transmitter can, within the data carrousel, include the URL to the assignment, classification or correlation server (350) into the transferred functional unit (50-X) and thereby as well the transmitter-specific assignment, classification or correlation server assigned to the user. Because the application or software from the data carrousel is deleted after changing the channel, the user cannot use the transmitter-specific assignment, classification or correlation server anymore after the channel has been changed.

In the first request (211) to the assignment, classification or correlation server (350) the request is transferred via a gateway server (310) into the Internet and is delivered as a query (211a) to the assignment, classification or correlation server (350). The assignment, classification or correlation server (350) answers this request by means of assigning of time index, identification and/or signature data that are contained in the request with supplying, provisioning or stocking of link data related to content-related additional data.

The link data are transferred to the requesting STB by means of the gateway (310). As a reaction or response on the reception of link data, which in particular, comprise only one IP address, a second web server (380), which is described or determined by means of link data is requested with time index, identification and/or signature data. The data are provided from the server (390) via gateway (310) and the data transfer processes (222) and (222a).

The second server is providing Web content, which is output by the client-sided additional data output device (30-X). The content can include further link data. Another external web server (390) can be addressed by link data, which are provided by the second web server (380). Alternatively, the STB (10-X) unit can directly connect to the server (390) via Gateway (310) by means of a direct link data. Within this preferred embodiment, the assignment, classification or correlation server (350) is requested, if the user sends out an activation signal by means of his RC (40-X).

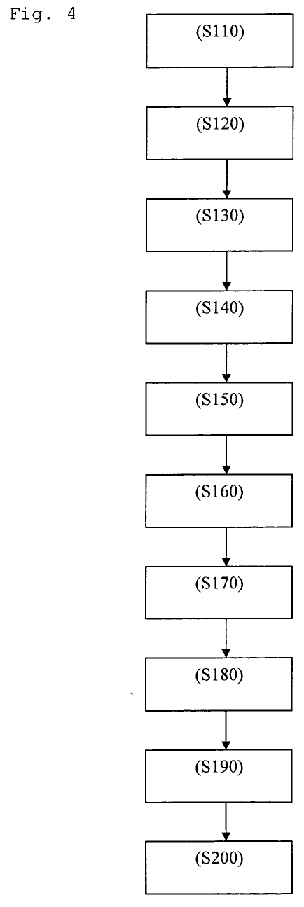

Because of the different platforms, on which the client-sided functional unit should be installed, and for the visualization engines that are realized on these platforms, a standardization of the data interface (315) between client (10) and assignment, classification or correlation servers (350), a data interface (325) between client (10) and web servers (380) is necessary, as far as content-related additional data for a video is requested by a Web server (380). FIG. 4 describes a concrete sequence of operations of the method used to operate the device, according to the invention, in particular the system with the assignment, classification or correlation unit (350).

In the process step (S110) the video content is received by the set top box (10-X) and displayed or output on the TV Screen (15-X). The user activates the remote control in the process step (S120) in a manner so that the user can expect to get further content-related additional data to the content that is displayed on the TV Screen. By the activation of the functional unit via the Remote control a video frame that was displayed in the output device (15-X) and further additional data that are assigned to this picture are extracted in the process step (S130) by the functional unit (50-X) or (50-Z) in a predetermined manner. In the process step (S140) time index data, marking, labeling, tagging or identification data and/or signature data are extracted, created or generated by the corresponding means that were installed on the functional unit (50-X) or (50-Z). In the process step (S150) by means of the extracted or generated time index data, marking, labeling, tagging or identification data and/or signature data the server-sided assignment server (first server) is requested in order to assign, in the process step (S160), link data that are linked to web servers (the second servers) by means of a server-sided assignment, to server-side received data. In particular link data to web servers, which comprise content-related data to the client-sided displayed video, are provided for a client-sided request. In the process step (S170) server-sided link data are received, in which the link data contain URLs to further content-related data and/or Web servers, in particular link data to the second server. In the process step (S180) query, retrieval or request data are sent to the second server or Web servers as a reaction to the reception of the corresponding address. In the process step (S190) additional data that are assigned on the web server to the time index data, marking, labeling, tagging or identification data and/or signature data and/or for the received additional data of the assignment, classification or correlation server are provided, so that in the process step (S200) the client is receiving these additional data from the second web server and is displaying it on the client-sided additional data output unit (30-X).

Further Advantages and Embodiments

According to the invention videos such as films, documentations, interviews, reports, TV shows as well as commercials, which are distributed via a transmitter or via another distribution mechanism (Internet, DVD), can also comprise these additional data. A viewer or user can extract a video frame from the video or from the corresponding data stream by means of an extraction unit, in particular by means of a program or by means of a plug-in within the video display or player unit (media player) that sends data by means of offered transmission means (such as a data interfaces contained within the program) to the corresponding server and subsequently receives detailed information or content-related additional data related to the content of the picture and/or to the content of the scenes. Thereby, in accordance with the invention, a more extended integration of the broadcast based television in the Internet, in particular into the Peer-to-Peer based and/or client-server based Internet, will be possibly without, in an advantageous manner, further costly technical measures that would be necessary for the transmitter infrastructure of the TV broadcaster.

In a manner, according to the invention, registered content, which is content that has been provided by the owner or by the transmitter to the server, according to the invention, can, by means of registration, previously announced content, be provided with scene-dependent additional data or with link data.

In another advantageous further embodiment of the invention the registering of content can create so-called registration data, which are assigned to the signature data. Since signature data, by means of a fingerprint algorithm, comprise for a given video only a limited number or amount of data, the signature data are a scarce good or a scarce resource. By the shortage or scarcity of these data a secondary marketplace, such as licensing, can be created, as long as the amount of units that process these data are restricted and/or can be controlled as well.

In another advantageous embodiment of the invention the signature data can be assigned to an address of a server on which further, content-related additional data can be provided to the signature data. The assignment, classification or correlation data of signature data or content dependent fingerprint data to server addresses can be managed by a separate assignment, classification or correlation server and can be provided to the users by means of client-sided queries or requests. Since only registered signature data can refer directly to server addresses, the user can be informed, by means of time index data and/or characterizing or distinctive marking, labeling, tagging or identification data, about web server addresses, which by means of the time index data and/or marking, labeling, tagging or identification data are assigned on the server-side. If no addresses are found for content-related additional data by means of time index data and/or marking, labeling, tagging or identification data within the assignment, classification or correlation unit, in an extension or expansion of the invention, the URL of a web portal can be sent to the client-sided unit so that the user via the standardized or default, web-type content, which contain link data that can be manually activated, can surf to content-related data.

The assignment, classification or correlation unit can be operated by the broadcaster or transmitter of the video content, if this one delivers the client-sided functional unit by means of the data carrousel and/or if he has the control over the client-sided, functional unit. The assignment, classification or correlation unit can also be operated by the owner of the STB or by the client-sided run-time engine or by the operator of the gateway server since these operators are able to deliver a functional unit for content-related additional data to the user.

In another embodiment of the invention the address of the assignment, classification or correlation server can be inserted into additional data that are contained within the content by means of the transmitter. In particular, these methods are advisable or advantageous, if the signature data cannot be integrated and be made searchable in a very big database early enough, as it is for instance, the case with live content. In this case, a smaller assignment, classification or correlation unit, in which data can be more quickly updated, is realized via a corresponding URL within the functional unit and provided to the user.

The use of an assignment, classification or correlation server or the controlled set of assignment, classification or correlation servers has the advantage that the content owners can register their content can make the access or the use of these data depending on licensing. The licensing of these assignment, classification or correlation data, which are referring to the server which, is connected to additional business processes, which would not exist without the solution, according to the invention. Furthermore the licensing of the data has the advantage that the detailed, content-related and/or scene dependent additional data do not have to be inserted and or maintained by the content owners. In addition, the registration data owner can change the corresponding licensee by the change of the server address that is assigned to the signature data at any time, or he can assign several licensees to the same content. Therefore there is no necessity to assign registration data to only one licensee exclusively. On the contrary, by the assignment of subsets of registration data to different licensees, content can by means of signature data that are contained in the content, the broadcaster or transmitter can offer the user only his signature data and he can thereby be certain that the user is redirected only to his web server by means of the assignment, classification or correlation server.

The licensor can recognize, by means of the signature data specific access data, which are managed by the assignment, classification or correlation server, that only by means of the licensed signature data the transmitter or broadcaster can create or generate additional income from, such as direct response marketing measures (Infomercials or the like).

The licensors, in particular the content owners, have the opportunity by means of the device, according to the invention to benefit directly from the advantages of the interactive television and in particular of the advantages of interactive advertising.

Another method of multiple licensing of content consists of the use of time index data or distinctive or unique marking, labeling, tagging or identification data such as server names or the like which are evaluated in relationship to the signature data. Thereby, registration data to syndicated content can separately be commercialized and used in different regional markets.

Particularly advantageous is the device, according to the invention, for the assignment of product related advertising to the watched TV content, without interrupting as done with the current inserted advertising. Instead the user is, as in the Internet, in control, of what he wants to see. The advertising that is activated by him is more relevant in contrast with inserted television advertising, which is pushed to the viewer without a direct reference to him. The link data offered to the user, according to the invention, enables the user to watch only the advertising or content that is chosen by him.

Therefore, the device, according to the invention, provides the same advantages as the Internet: control, choice, convenience and speed. The device, according to the invention, enables the data exchange of signature data between viewers so that instead of verbally reporting the seen TV show, the signature data can be sent to a second person and this person can use the signature data by means of its functional unit, and the second person gets the same additional data. In particular, the second person can be enabled by means of link data, to watch the corresponding video which provides additional income and proceeds for the owner of the content or transmitter by means of Content- or Video-on-Demand.

On the device, according to the invention, content-related additional data will be provided to client web server which is independent of the a The assignment of content-related additional data by means of terms, concepts, category names, scene definitions and descriptions and link data can then be provided by a separate server.

The device, according to the invention, enables the server-sided assignment of additional information (terms, concepts, link data, web pages) and metadata to continuous stream or videos which are published as video data, whereby the additional data and/or metadata are influencing in a content-related and context-describing manner on the continuous or uninterrupted contents of a scene (which extends on several ongoing video frames). The scenes are set on the server-side in a direct relation to the textual description of the content by means of corresponding data.

The Internet provides users or viewers of a video by means of the invention the opportunity to extract, select and to display context related, in particular relevant, metadata in relationship to the video. In particular, by means of utilizing hyperlinks in the output the viewer or user has the opportunity to make use of a large number of relevant information.

The use of the server-sided data by a client or a client-sided user or viewer can be reached efficiently by means of standardized interfaces, in particular by means of XML and XML over HTTP (SOAP—Simple Object Access Protocol).

The outputting or displaying of terms can be done by means of a menu, in which more detailed option can be created by means of pull-up, drop-down or explorer (list like or directory like) organization of information. A menu element can either be a link data element to further information or it can be a list or directory in which either further link data or additional menu options are offered. Alternatively also multimedia text (text with pictures, videos, animations or interactions) can be output, displayed or distributed after the activation of menu options. In this manner link data element can be output or displayed or the link data element can immediately be output or displayed in data, which can be called by means of link data.

In another extension or expansion of the invention the client-sided output or display of the menu can be created or generated by means of further configuration information related to the selected terms. Therefore, by means of the server appliance, according to the invention, a video frame can be extracted or assigned to a plurality of scene data, which can be assigned to a plural of extracted or assigned terms which can be extracted or indicated by means of a hierarchy from different steps and from incoherent or unconnected ranges of the term hierarchy. The terms which are assigned to the scenes can directly be realized within a one-level menu in which the terms are listed in linear manner and for an activation of a menu element, a list of hyperlinks appear at which the link data comprises a title, corresponding description and/or an icon. Since there is the opportunity that many data are displayed or output, the output can be limited in the menu list and in the hyperlink list to a restricted number and by means of a back/forward button for navigating between the output elements can be made possible.

In an extension or expansion of this concept, the menu elements can be grouped or separated into categories, e.g. as etiquettes (or tags) above the data window or that enable a representation in a two-step menu.

Another advantage of the invention consists of the control of the menu by means of administering corresponding terms by means of the server. The validation of the correctness or utilizibility of terms that will be displayed or output in relationship to the client-sided video can be validated within a server-sided data processing apparatus and/or by means of a further electronic network connected term verification, inspection and examination server. The verification, inspection and examination server can be a catalogue of terms or it can be a server on which the use of brand names is checked and/or connected with additional data.

The additional data, delivered by the server, can constitute or initiate the business preparation or development between the user of the brand name and its owner or agents or the data could contain conditions, which the user of the brand name has to satisfy, such as a payment for the use of the brand name, or the mandatory use of the link data, which must be included in the corresponding link data table and/or the restriction or condition that no further link data to the brand name should be included in the link data table.

In addition, these data restrictions, which are delivered or informed by the verification, inspection and examination server, can contain and prohibit assignment to protected terms on scenes or videos or video genres.

Another advantage of the invention is to give by means of using, including, inserting or embedding of a term verification, inspection and examination server or term verification, inspection and examination service as a means of enforcing rights related to brand names. The terms are used preferably as titles on the menu elements. With an external control of these terms or of the menu titles and with the validation of the terms with respect to possible brand name infringements, the operator of the device can, according to the invention, be informed automatically about these legal problems. Additionally, by means of this service, business preparation or developments can be made possible which would not arise without this service. The term examination, inspection or verification can be an additional web service, which can be offered to satisfy the interest of the trademark owner. By means of control over the menu title elements the brand name owner can enlarge or extend his influence on the use of his name in an advantageous manner and increase the value of the brand name significantly.

In a further embodiment of the invention the terms can be translated into the language of the user or viewer by means of a catalog unit or a translation unit before they are displayed on menu elements as a title.

Furthermore, within the output, instructions can be inserted in the data that are meant for the client by means of determining the sequence or order of the data. Alternatively the data can be changed in their order or sequence by means of instructions on the server, in particular within the processes for the supplying, provisioning or stocking of data. The sequence or order of the term or menu elements or the link data lists can be changed by instructions and determined or fixed before the output occurs.

These methods can also be used, when term and link lists, based on the merging of scenes, must be merged and reordered.

A further embodiment of the invention can consist of a direct assignment of link data to scenes.

The additional data which are delivered by the server, according to the Invention, can be used in the client-sided document visualization/output/representation unit, so that the corresponding content, for instance a scene or a temporal interval, which is in a predetermined timely distance to the requested element will not be output, so that for example within a parental control system, questionable content could be suppressed or skipped in the client-sided output by means of server-sided additional data.

These methods comprise the advantage that parental control data does not have to provide this information to the display or player unit only at the beginning of the file or data stream. The display or player unit can start at any time within the video to play the content, and it can request corresponding data on the server side, in particular if the corresponding data doesn't exist in the video on the client-side any longer or was removed.

Category names or terms can contain in the term table directly one list or set of server addresses with corresponding parameters (for example URLs) whereby these addresses or URLs can comprise additional text, description(s), picture(s), video(s) or executable script(s). Terms can be taken from a catalog unit. These terms or category names are invariant terms or concepts. Equivalent translations into other languages can be assigned to these category names and be inserted in the corresponding catalog unit as a translation for a term. A multilingual term-based reference system can be created in which to every used term a video scene can be shown. Additionally, creators or editors can extend the catalog of subcategory names and/or of further term relationships between category names within the framework of Open Directory Initiatives.

In another concrete embodiment of the invention, the additional data are visual, acoustic or multi-media data or they are description data or predetermined utilization operations, such as hyperlinks which refer to predetermined server-sided document server units or product databases, which are activated and/or questioned by a user or the additional data are data which are assigned directly to the mentioned data.

In another embodiment, the utilization operations can also be predetermined dynamic script instructions which output data on the client-side and/or display or output these server-sided received data. From the server-side databases or server, further content related terms or additional data, can be requested by means of the digital content signature data or by means of terms or additional data, which are assigned to the signature data. These additional data can subsequently and on the client-side be output or displayed stores and/or reprocessed by the client-sided data processing unit.

In another embodiment of the invention, the additional data which are delivered by the server, according to the Invention, can be used in the client-sided document visualization/output/representation unit, so that the corresponding content, for instance a scene or a temporal interval, which is in a predetermined timely distance to the requested element will not be output, so that for example within a parental control system questionable content could be suppressed or skipped in the client-sided output by means of server-sided additional data.

In a further concrete embodiment of the invention, the additional data delivered by the server according to the invention, can be transferred, stored and/or managed on a client-sided data storage appliance or unit, so that without further server requests the client-sided stored additional data can be displayed, output, queried, indexed, searched and be reused for a video offline.

By means of additional data related to the landscape videos of landscapes or vacation spots can be found over the Internet. The assigned videos or video scenes can display hotels or ruins or other vacation destinations. Another advantage of the present invention is based on the circumstances that created by the producer, additional data don't make web pages excessive or unnecessary, but facilitate the surfing between similar web pages for the viewer or the user. Furthermore the invention enables a user of a video to receive content-related web pages and new visitors or viewers would come, by means of server-sided additional data, increased value, to these web pages.

By means of additional data or terms, video data or video scenes can comprise a territorial assignment, such that, for instance, the recording or shooting of videos or of a scene can be found with additional location based data.

In the same manner, pictures, images or videos of objects (works of art) can be found by means of standardized category terms or terminology. In the same manner, training or educational movies, or computer simulations can be supplied and found with keywords.

The additional data can represent structured descriptions of landscapes or certain objects like buildings or acting persons. These data can be provided to a search engine. This gives someone the opportunity to find the content via the external scene descriptions for movies or videos without knowing that this was specifically intended as such by the Publisher. Video(s) or picture(s) can therefore be found on the Internet specifically via textual descriptions of portions of content.

These additional data can be assigned on the server-side independently of the real publication or of the original publisher of the video or video scene and it can lead the interested user to the web site of the publisher or to a place of purchase for the document. Supposing these data were stored as additional data on the server, according to the invention, in this manner, with the creation of registered content signatures, further link data and additional, value-added business processes can be tied in.

The metadata or additional data for the video content can contain historical background information or its meaning, thereby providing the interested user or viewer additional information delivery.

The same benefit arises from the subsequent attachment of information to works of art, paintings, movies, architectural buildings or structures, animals, plants, technical objects such as machines, engines, bridges or scientific pictures, images, videos, files, programs or simulations from medicine, astronomy, biology or the like. Also, shown trademark logos within videos can be represented or can be made searchable in the database, according to the invention, by means of the corresponding additional data. As a result, a trademark owner can get information about the distribution of his logos and to the context of usage of the logos.

Furthermore, concrete objects or items such as pictures, images of consumable products or investment goods can very precisely be described with additional data as well, and can be represented in the database according to the invention. Since additional data can also be given to search engines, video scenes could therefore be found more easily on the Internet.

Additionally, for videos, which are in the possession or within access of the user or viewer, additional data can be downloaded from the server onto the local storage unit of the computer, such that subsequent searches can be done independent of remote and of unfamiliar server-sided resources, and such that in an advantageous manner, the protection of privacy within the search can be guaranteed to a much larger degree than within an online search.

The preferred Fingerprint method has the attribute, feature or quality such that the result of the application of the fingerprint methods is insensitive with respect to small changes in the picture elements, in particular pixels. This is achieved by the usage of averaging instructions on grey levels in the pixels that are contained in the corresponding areas of the picture. Preferably a method is used that transforms every picture into a standard size—for example 8*8 pixels or 12*12 or 16*16, which is called in the following thumbnail, and which comprises, for every pixel of the thumbnail, a corresponding color or grey levels depth such as 8 bits, 12 bits or 16 bits for every pixel contained in the thumbnail. In the transformation of the original picture onto the thumbnail, each pixel of the thumbnail corresponds to an area of the original image. By the use of mathematical methods the color error can be reduced (and its impact can be made insignificant). After the transformation into grey levels, an average grey level value can be calculated from this area by averaging over all corresponding (relevant) pixels. In addition, rules can guarantee that pixel on the border or edges are taken only into account with the corresponding fraction of their value. With this averaging, the influence of some or a few pixels is negligible. As soon as the methods for the creation of these fingerprints are standardized, these fingerprint data can also be created or produced on the client-side and be searched in the database. Possible methods to find and search fingerprints within a database consist in the repeated application of averaging (of grey values) over areas within the fingerprints in order to get data of a length, which is indexable in the database. The indexing method is variable and can be adapted by means of optimization to the size of the database.

Another advantage and application of the present invention consists of the automated transfer of server-sided additional data to the client, in particular if the activation unit creates or produces an activation signal in a time-controlled and/or periodical and/or in an algorithmically-controlled manner and the client-sided reception unit or receivers receive the extracted data and the client-sided output device displays or outputs content-related updated additional data, which are updated in and to the video content. In an embodiment of the invention script instructions or program software instructions that are contained in the additional data, which are delivered by the server, can be used to activate the activation unit in order to update the client-sided displayed or output content.

Table of References

The following table contains additional descriptions of the references to FIGS. 1 to 4, and it is part of the present invention and its disclosure.

Reference Descriptions Are:

| | |
|---|---|
| (1) | Means for the sending, transmitting or broadcasting of |
| | data or source of data in particular audio/video data |
| (10) | (client-sided) electronic data processing unit |
| (10-X) | Set-Top-Box as an example for an client-sided data pro- |
| | cessing unit |
| (15) | Data-reception unit or means for the reception of data |
| | from the input channel(s) (100) |
| (15-X) | TV screen as an example of an TV, Video visualization, |
| | output or representation unit |
| (20) | Backchannel or means for the sending, transmitting or |
| | broadcasting of data from the client to the server |
| (25) | Audio/video data or data and means for the management, |
| | administration and providing, provisioning or supplying |
| | of audio, video data by means of data, whereby these |
| | data can also consist of control- and steering or regu- |
| | lation data and/or data |
| (30) | Visualization, output or representation unit or au- |
| | dio/video- and data Visualization, output or representa- |
| | tion, or means for the visualization, output or repre- |
| | sentation of audio/video data (25) and/or means for the |
| | visualization, output or representation and/or output of |
| | a plurality of additional data |
| (30-X) | Output of additional data via for example of the web |
| | browser that is running or executing on the STB and is |
| | displayed, outputted or visualized on the TV screen |
| (40) | Input unit or means for the input of data or commands by |
| | or via a user |
| (40-X) | Remote-Control (RC) as example of an input unit |
| (45) | Control or activation unit or means for the control or |
| | activation of the function unit (50) in particular by |
| | means of the manual activation or action of a user by |
| | means of an input unit (40) |
| (46) | Signal(s), or data that are created or generated by the |
| | control unit (45 and is received by the function unit |
| | (50) |
| (50) | Function unit or means for the access to data in the |
| | visualization, output and representation unit (30), cal- |
| | culation, creation or extraction of data from the audio- |
| | visual content (25), and transmission or broadcasting |
| | and reception of data to or at the server unit (200) and |
| | output of the received data in the visualization, output |
| | and representation unit (30) |
| (50-X) | Function unit or client-sited control unit for the re- |
| | quest, transmission, transfer, reception and visualiza- |
| | tion, output and representation of additional (server- |
| | sided) information |
| (50-Z) | Function unit, which is designed as Runtime-Engine or |
| | Java VM or as middleware |
| (55) | Time index generation, creation unit or extraction-unit |
| | or time index unit or means for the creation, generation |
| | of time index data (56) |
| (56) | Time index data, or data or data records, which enables |
| | an assignment on a point in time or time interval |
| (60) | Content identification unit or means for the unambiguous |
| | marking, labeling, tagging or identification of audio |
| | visual data by means of extracting or generating or cre- |
| | ating of marking, labeling, tagging or identification |
| | data (65) |
| (62) | Signature data creation-, generation- and/or extraction |
| | unit, or means for the extraction or generation, crea- |
| | tion of signature data |
| (65) | Marking, labeling, tagging or identification data or |
| | data or data records for the unambiguous description |
| | and/or characterization of audio/video data (25) |
| (70) | Transmission- and input or reception unit or means for |
| | the transmission or broadcasting and/or for the recep- |
| | tion of data to and/or of a server unit (200) |
| (75) | Selection unit or means for the selection and creation |
| | of a set of additional data from the received set of |
| | server-sided additional data |
| (80) | Additional data reception unit or means for the recep- |
| | tion of additional data of a server in particular by |
| | means of the back channel(s) (20) or of the reception |
| | channel(s) (100) |
| (90) | Output unit for additional data or means for the output |
| | or visualization of additional data in a visualization, |
| | output or representation unit |
| (100) | Reception- or input channel, means and/or medium that is |
| | sending, broadcasting and/or receiving audio/video data |
| | (25) in and/or via a sender or transmitter (1) and/or |
| | audio/video source |
| (200) | Server unit or server device or appliance |
| (211) | First request on the assignment server for the IP Ad- |
| | dress or URL of further information; whereby the data |
| | within network range, area or domain, which is protected |
| | via the gateway (310), are transferred to the gateway |
| (211a) | Connection of the STB which data have been passed after |
| | the passing via the gateway to the first server or as- |
| | signment server |
| (222) | Request of the second web server for content related ad- |
| | ditional data within the network range, area or domain |
| | that is separated by the gateway |
| (222a) | Connection of the STB which data have been passed after |
| | the passing via the gateway to the second server or as- |
| | signment server or additional data server or web server |
| (250) | Data assignment unit or means for the providing, provi- |
| | sioning or supplying of additional data and/or means for |
| | the assigning of time index value(s) and/or marking, la- |
| | beling, tagging or identification data (65) to addi- |
| | tional data |
| (300) | Sender, broadcaster or TV sender or TV broadcaster, as |
| | example for a user of the present server sited compo- |
| | nents according to the invention |
| (310) | Gateway for the access on a server, which is accessible |
| | via Internet |
| (315) | Data interface, in order to be able to communicate with |
| | the assignment server |
| (325) | Data interface, in order to be able to communicate with |
| | the web server |
| (350) | First server or assignment server |
| (380) | Second server (web server) |
| (390) | Further external web server |
| (S5) | Process step for the reception of audio/video data (25) |
| | from a reception channel (100) in a data reception |
| | unit(15) |
| (S10) | Process step for the visualization, output or represen- |
| | tation of audio/video data (25) in the data visualiza- |
| | tion, output and representation unit (30) |
| (S15) | Process step for the activation of the function unit |
| | (50) by means of a signal (46) that is created by an ac- |
| | tivation unit (45) |
| (S20) | Process step for the creation or generation of time in- |
| | dex data (56) in the time index data creation, genera- |
| | tion or extraction unit (55) |
| (S30) | Process step for the generation, creation or extraction |
| | of marking, labeling, tagging or identification data |
| | (65), which are marking, labeling, tagging or identify- |
| | ing the audio/video data (25) |
| (S40) | Process step for the transmission or transfer of time |
| | index data (56) and marking, labeling, tagging or iden- |
| | tification data (65), by means of the transfer or trans- |
| | mission unit (70), in particular by means of backchan- |
| | nel(s) (20), to the server unit (200) |
| (S50) | Process step for the providing, provisioning and supply |
| | of server-sided additional data by means of a server- |
| | sided assignment unit (250) |
| (S60) | Process step for the reception of server-sided addi- |
| | tional data by means of the addition data reception unit |
| | (80), |
| (S70) | Process step for the selection of received additional |
| | data and generation or creation of a set of additional |
| | data that is visualized, output and represented by means |
| | of the selection unit (75) |
| (S80) | Process step for the client-sided visualization, output |
| | and representation of additional data in an output unit |
| | (90) |
| (S110) | Process step for the reception of video content on the |
| | Client (10-X) and visualization, output or representa- |
| | tion on the TV screen (15-X) |
| (S120) | Process step in which a user activate the RC (40-X) |
| (S130) | Process step for the extraction of data corresponding to |
| | video frame data that are visualized, output, and repre- |
| | sented in the output unit (15-X) |
| (S140) | Process step for the extraction or creation, generation |
| | of time index data, marking, labeling, tagging or iden- |
| | tification data and/or signature data by means of means |
| | installed on the function unit (50-X) or (50-Z) |
| (S150) | Process step for the request of the server-sided assign- |
| | ment server (first server) by means of extracting or |
| | generating time index data, marking, labeling, tagging |
| | or identification data and/or signature data |
| (S160) | Process step for the server-sided assignment of data, in |
| | particular link data to the web server, which in par- |
| | ticular provide or supply content-related data to the |
| | client-sided displayed, outputted or visualized video |
| (S170) | Process step for the reception of link data in particu- |
| | lar URLs to further content-related data and/or server |
| | (in particular link data to a second server) |
| (S180) | Process step for the request of (second) web-server as |
| | reaction on the reception of additional address |
| (S190) | Process step for the assignment of time index data, |
| | marking, labeling, tagging or identification data |
| | and/or signature data and/or additional data from the |
| | assignment server on content-related, in particular to |
| | the client-sided displayed, outputted or visualized |
| | video related, additional data and its providing |
| (S200) | Process step for the reception and visualization, output |
| | and representation of additional data of the second web |
| | server |

1. System for the client-sided requesting, transmitting, receiving, delivering, outputting and displaying of server-sided stored additional data by means of a reception channel received video data (25), in a by means of an corresponding client-sided, electronic data processing units (10),
characterized by
client-sided means for the creation and/or extraction of marking, labeling, tagging or identification data, time index data and/or signature data from the video data and for the transferring, transmitting or delivering of these data to the server unit as reaction on a by a user inserted client-sided activation signal, whereby the insertion of the activation signal is not dependent of a format, a predetermined property or a predetermined preparation of video data, in particular realized as movie or multimedia content,
whereby the server unit (200) comprises an assignment unit (250), which is designed to assigning and selectively providing of the server-sided additional data that are assigned to the video data in a content-specific manner, as reaction on the transferred or transmitted marking, labeling, tagging or identification data, time index data and/or signature data,
and client-sided means for the receiving, displaying and outputting of the additional data are designed so that the user of the additional data sees it in connection with the video data, in particular at the den moment of the activation signal displayed video data.

2. Method for the client-sided requesting, transmitting, receiving, delivering, outputting and displaying of server-sided stored additional data,
characterized by the following steps:
Receiving, displaying and outputting of video data (25) by means of a reception channel in a client-sided, electronic data processing unit (10), and
Activating a client-sided means for the creating and/or extracting of marking, labeling, tagging or identification data, time index data and/or signature data from the video data by means of an activation signal that is activated by an user and
Server-sited providing of content-related additional data which is corresponding to the marking, labeling, tagging or identification data, time index data and/or signature data from the corresponding assignment unit (250) that is related to a server unit (200) as reaction on the transferring or transmitting of the marking, labeling, tagging or identification data, the time index data and/or the signature data to the server unit (200) and
Client-sided receiving, displaying and outputting of additional data, which the user in connection with the video data, in particular at the den moment of the activation signal displayed video data can see.
